(19) United States
(12) Patent Application Publication
(10) Pub. No.: US 2013/0220671 A1
(43) Pub. Date: Aug. 29, 2013

(54) WIRE GUARD

(71) Applicant: Justin Fischbach, Olmsted Falls, OH (US)

(72) Inventor: Justin Fischbach, Olmsted Falls, OH (US)

(21) Appl. No.: 13/584,139

(22) Filed: Aug. 13, 2012

Related U.S. Application Data
(60) Provisional application No. 61/522,297, filed on Aug. 11, 2011.

(51) Int. Cl. H01B 17/16

(52) U.S. Cl. CPC H01B 17/16
USPC 174/163 R

(57) ABSTRACT

A guard for protecting wire along an interface between first and second portions of ground includes a base that extends along a centerline from a first end to a second end. The base includes a first surface for engaging the first ground portion and a second surface for engaging the second ground portion. A slot extends from the first end towards the second end for receiving the wire such that the second end of the base protects the wire from impact.

### RELATED APPLICATIONS

This application claims priority to U.S. Provisional Application Serial No. 61/522,297, filed Aug. 11, 2011, the entirety of which is incorporated herein by reference.

### TECHNICAL FIELD The present invention relates to a guard for wire and, in particular, relates to a guard for visually marking and protecting hidden wire.

### BACKGROUND

Over the years, communication lines for residential or commercial use have transitioned from pole-to-pole travel to being buried underground. Burying these wires protects them from environmental conditions, e.g., rain, lightning or falling tree branches, and provides a more aesthetic look to the property by eliminating a myriad of obtrusive and generally unattractive wires. Examples of wires or cables that may be buried underground and run throughout one's yard or driveway in a residential or commercial setting include low voltage power lines, cable, phone or internet wires, and perimeter designation wires for invisible dog fences.

While burying the wires provides the aforementioned advantages, one problem that arises is that it becomes difficult to relocate the wires in the yard or driveway once obscured from view. As a result, the wires or cable may be inadvertently cut, split or severed by yard equipment, e.g., weed whacker or power edger, which passes over the buried wire or cable. Accordingly, there is a need in the art for a device that indicates the location of the buried wire or cable and protects the wire or cable during use of yard equipment in the area.

### SUMMARY OF THE INVENTION

In accordance with an embodiment of the present invention a guard for protecting wire along an interface between first and second portions of ground includes a base that extends along a centerline from a first end to a second end. The base includes a first surface for engaging the first ground portion and a second surface for engaging the second ground portion. A slot extends from the first end towards the second end for receiving the wire such that the second end of the base protects the wire from impact.

In accordance with another aspect of the present invention a method for protecting a wire along an interface between first and second ground portions includes providing a wire guard having a base extending along a centerline from a first end to a second end, the base further including a slot extending from the first end towards the second end. The wire is located and the wire guard is inserted between the first and second ground portions until the wire is positioned within the slot in the base such that the second end of the base protects the wire from impact.

In accordance with another aspect of the present invention a guard for protecting wire along an interface between first and second portions of ground includes a base that extends along a centerline from a first end to a second end. The base includes a first surface for engaging the first ground portion and a second surface for engaging the second ground portion. A flange extends transversely from the first surface of the base for engaging an upwardly facing surface of the first ground portion. A plurality of openings extends through the base for receiving fasteners to secure the base to the first ground portion. A slot extends from the first end towards the second end for receiving the wire while the flange engages the first ground portion such that the second end of the base protects the wire from impact.

Other objects and advantages and a fuller understanding of the invention will be had from the following detailed description of the preferred embodiments and the accompanying drawings.

### BRIEF DESCRIPTION OF THE DRAWINGS

FIG. 1 is a schematic illustration of a wire guard in accordance with an embodiment of the present invention;

FIG. 2 is a rear view of the wire guard of FIG. 1;

FIG. 3 is a top view of the wire guard of FIG. 1;

FIG. 4 is a right side view of the wire guard of FIG. 1;

FIG. 5 is a schematic illustration of the wire guard of FIG. 1 aligned with an underground wire having a first configuration;

FIG. 6 is a schematic illustration of the wire guard of FIG. 1 protecting the underground wire of FIG. 5;

FIG. 7 is sectional view of the wire guard taken along line 7-7 of FIG. 6;

FIG. 8 is a schematic illustration of a wire guard in accordance with another aspect of the present invention;

FIG. 9 is a schematic illustration of the wire guard of FIG. 1 in an alternative location; and

FIG. 10 is a sectional view of FIG. 9 taken along line 10-10.

### DETAILED DESCRIPTION

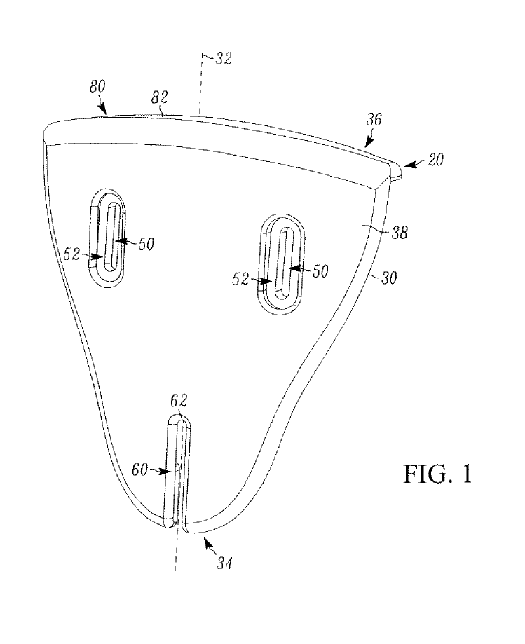

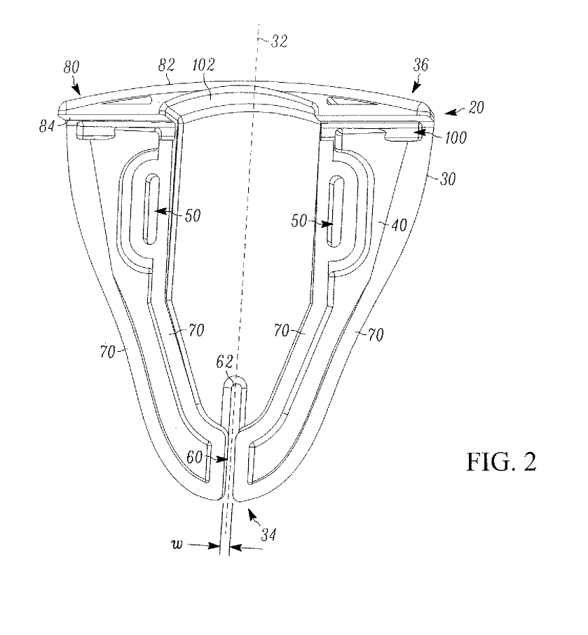

The present invention relates to a guard for wire and, in particular, relates to a guard for visually marking and protecting hidden wire. FIGS. 1-4 illustrate a wire guard in accordance with an embodiment of the present invention. As shown in FIGS. 1-2, the wire guard 20 includes a base 30 that extends along a centerline 32 from a first end 34 to a second end 36. The base 30 is generally triangular or wedge-shaped with rounded corners. The legs of the triangular base 30 may be curved, contoured or straight (not shown). Alternatively, the base 30 may have a circular, elliptical, rectangular or any polygonal shape in accordance with the present invention. The base 30 may be symmetrical or asymmetrical about the centerline 32.

The base 30 is formed from a durable material such as metal or plastic. Exemplary materials for the base include, but are not limited to, polyethylene, polypropylene, zinc, aluminum, and stainless steel. The base 30 may be molded, e.g., injection molded, or cast. In any case, the base 30 should be formed of a material that is weather-resistant, wear-resistant, and impact-resistant. The material of the base 30 may also be non-conductive to help protect wire insulation and prevent disruption of electromagnetic fields produced by the wire, e.g., in the case of invisible dog fence wires.

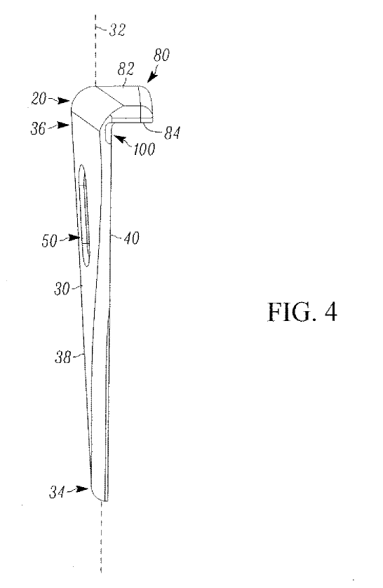

The base 30 includes a top surface 38 and a bottom surface 40. The top and bottom surfaces 38, 40 may extend substantially parallel to one another or may extend at an angle relative to one another. As shown in FIG. 4, the bottom surface 40 has a planar configuration. The top surface 38 is angled relative to the bottom surface and has a convex configuration. It will be appreciated that each of the top surface 38 and the bottom surface 40 may have any configuration, e.g., planar or curved, in order to meet desired environmental and use conditions.

Referring to FIG. 2, one or more ribs or reinforcing members 70 are formed in the bottom surface 40 of the base 30. The reinforcing members 70 add strength and rigidity to the base 30 and allow for excess material to be removed from the base in order to minimize weight and cost.

One or more openings 50 may extend entirely through the base 30. As shown in FIG. 1, an opening 50 is provided on each side of the centerline 32. Each opening 50 has an elongated, elliptical shape and extends generally parallel to the centerline 32. Alternatively, the openings 50 may be circular or exhibit a polygonal shape (not shown). The openings 50 may also extend at an angle relative to the centerline 32 (not shown). Each opening 50 includes an associated countersink 52 that spaces the opening from the top surface 38 of the base 30. The openings 38 are configured to receive a fastener to secure the base 30 to a rigid material, e.g., concrete. In one aspect of the present invention, the position of the openings 50 coincides with the approximate center of the thickness of the concrete on which the wire guard 20 is to be placed. Due to this configuration, cracking or damage to the concrete caused by penetration of the fasteners into the concrete will be minimized. Although a pair of openings 50 positioned symmetrically with respect to the centerline 32 is illustrated in FIG. 1, it will be appreciated that any number of openings (or none at all) may be provided in a symmetric or asymmetric pattern relative to the centerline 32.

A slot 60 extends entirely through the base 30 from the first end 34 of the base towards the second end 36 and terminates at a point 62. The slot 60 extends generally along the centerline 32 of the base 30 but may alternatively be spaced from the centerline or extend at an angle relative to the centerline (not shown). The slot 60 has rounded edges and a width (w) in a direction that is perpendicular to the centerline 32 and adapted to receive a wire or cable, e.g., invisible dog wire, low voltage lighting wire, phone or television line. The slot 60 is illustrated as having an elongated, substantially elliptical shape, but the slot may alternatively have shapes such as rectangular, triangular, semi-circular, etc. (not shown). Referring to FIG. 2, a second slot 100 extends along the bottom surface 40 of the base 30. The slot 100 extends substantially perpendicular to the centerline 32 of the base 30 and along all or part of the width of the base. The slot 100 is sized and configured to allow water or ice build-up to escape during use of the wire guard 20 in colder temperatures. The slot 100 also allows the wire guard 20 to be used in corner interface situations discussed below.

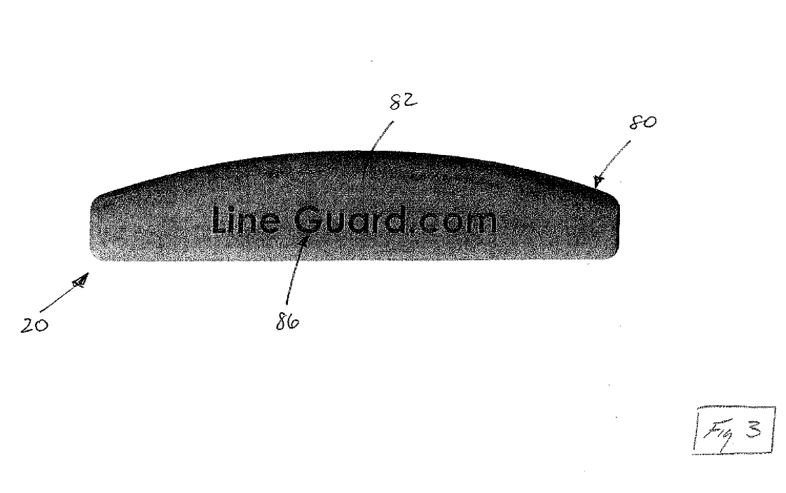

An optional flange 80 extends from the second end 36 of the base 30 in a direction transverse to the centerline 32 of the base. The flange 80 may be integrally formed with the base 30 or may be secured to the base via releasable fasteners (not shown) such as screws, clips, hooks, hinges or the like. As shown, the flange 80 extends substantially perpendicular to the bottom surface 40 of the base 30. The flange 80 has an elongated, generally rectangular shape and includes a top surface 82 and a bottom surface 84. The bottom surface 84 has a generally planar configuration and the top surface 82 has a convex shape (see also FIG. 4). The top surface 82 faces away from the base 30 and may include text and/or an image 86 that is visible during use of the wire guard (FIG. 3). The slot 100 formed in the bottom surface 40 of the base 30 is positioned adjacent to the intersection of the flange 80 and the base but alternatively may be spaced therefrom, e.g., closer to the first end 34 of the base. A notch 102 extends from the bottom surface 84 of the flange 80 towards the top surface 82. The notch 102 has an arched shape and is configured to receive large wires, e.g., low voltage wires.

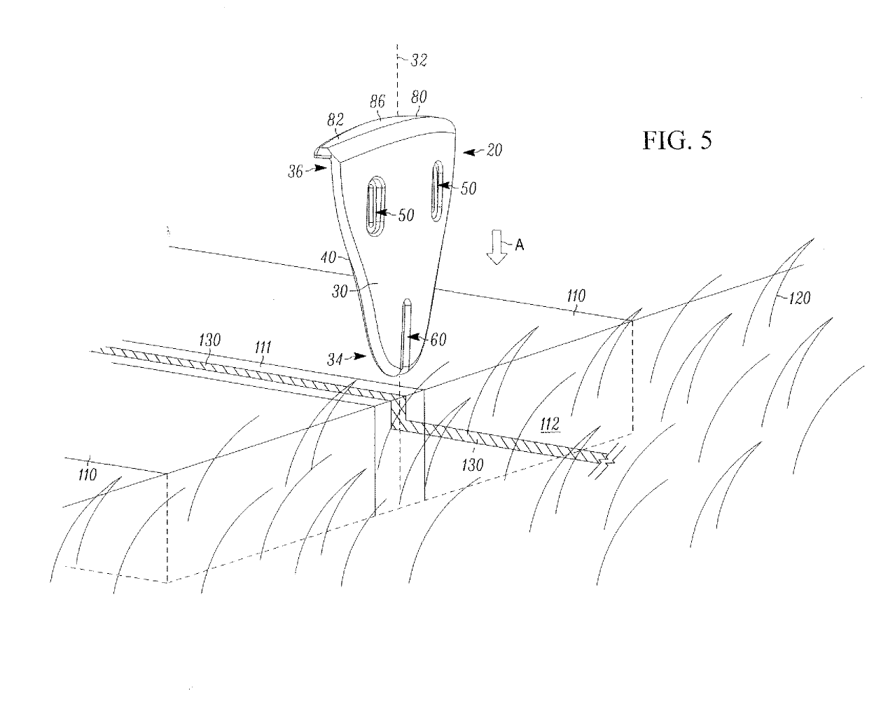

FIGS. 5-7 illustrate a method of using the wire guard 20 in accordance with the present invention. In use, a wire or line 130 to be protected is first located along the interface 112 between two surfaces on the ground over which the wire extends, e.g., an interface between concrete 110 and a yard or grass 120, using conventional techniques, e.g., radio-frequency transmitting. The interface 112 may alternatively be located between multiple concrete surfaces, e.g., driveway, sidewalk, street, etc., or multiple yard surfaces, e.g., mulch bed, grass, dirt, etc.

One portion of the wire 130 runs in a seam 111 between adjoining slabs of concrete 110 or the wire may be embedded within a single slab of concrete. A passageway (not shown?) may also be cut into the existing concrete 110 to receive the wire 130 and guide the wire to the ground 120. In any case, the wire 130 extends along the concrete 110 and into the yard 120, where it travels underground in the desired path and/or to the desired destination.

When it is desirable to protect the wire 130 for yard maintenance, etc., the wire guard 20 is oriented such that the bottom surface 40 of the base 30 faces towards the concrete 110, the top surface 38 faces the yard 120, and the top surface 82 of the flange 80 faces upward, i.e., the top surface is visible from above.

As shown in FIG. 5, the wire 130 extends within the concrete seam 111 and underneath the yard 120 in a direction that is generally perpendicular to the centerline 32 of the base 30. The wire 130 is therefore aligned with the slot 60 at the first end 34 of the base 30. The wire guard 20 is then driven downward into the yard 120 along the interface 112 between the concrete 110 and yard in the manner indicated generally by the arrow A in FIG. 5 to position the wire 130 within the slot 60.

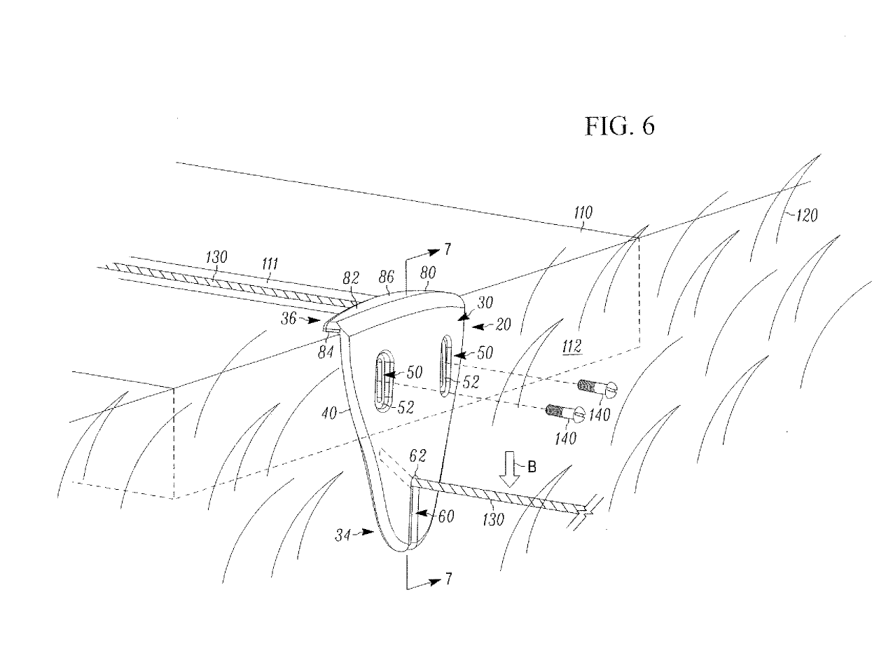

As illustrated in FIG. 6, further driving of the wire guard 20 into the yard 120 pushes the wire 130 within the slot 60 downward and away from its initial position in the manner indicated generally by the arrow B. The wire guard 20 is driven into the yard 120 until the bottom surface 84 of the flange 80 abuts the concrete 110. In this position, the wire 130 is positioned at the termination point 62 of the slot 60. As a result, the slot 60 holds the wire 130 out of position, i.e., deeper within the ground 120, to allow yard equipment to be used in proximity to the initial position of the wire along the interface 112 without damaging the wire. The edges of the slot 60 are rounded to minimize damage to the wire 130 passing therethrough. The wire 130 is therefore moved out of the likely position of a rotating edger blade or weed whacker wire used along the interface 112 between the concrete 110 and yard 120.

If openings 50 are provided in the wire guard 20, the base 30 is secured to the concrete 110 in a conventional manner. In particular, fasteners 140 are fed through the openings 50 and secured to the concrete 110 at about the midpoint of the thickness of the concrete, which is typically about 3″. The fasteners 140 may constitute tapcon concrete anchors or the like. The elongated shape of the openings 50 allows the base 30 to be adjusted vertically and/or rotationally relative to the interface 112 in order to accommodate concrete 110 that shifts or cracks over time. The head of each fastener 140 sits in the countersink 52 of the associated opening 50 when the fasteners fully engage the concrete 110, which allows the wire guard 20 to maintain a low profile.

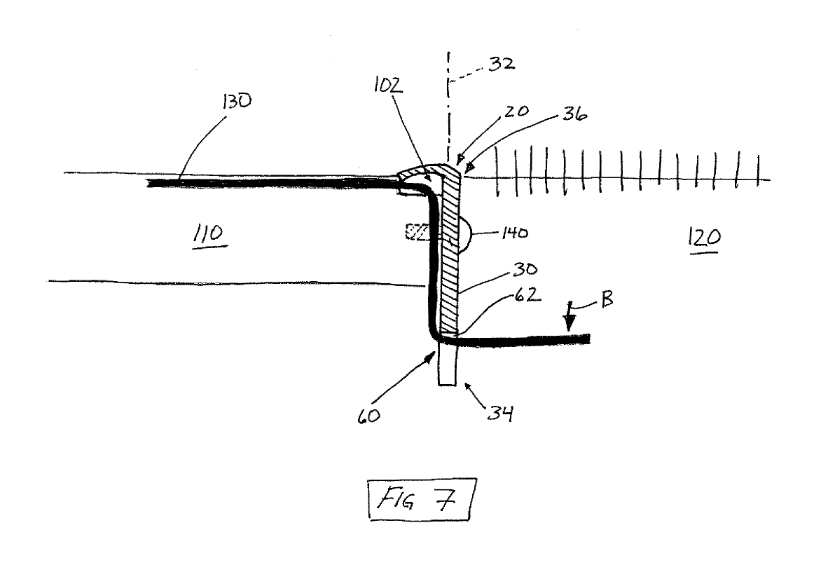

Alternatively or additionally, the bottom surface 40 of the base 30 is covered with construction epoxy to adhesively bond the wire guard 20 to the concrete 110. The bottom surface 84 of the flange 80 may also be covered with construction epoxy to further help secure the wire guard 20 to the concrete 110. In any case, as shown in FIG. 7 and with the wire guard 20 in place, the wire 130 extends along from the seam 111 of the concrete 110, into the notch 102, downwards between the interface 112 and the bottom surface 40 of the base 30 towards the first end 34 of the base, transversely through the slot 60 and out of the wire guard 20. The wire 20 continues along and within the yard 120. The wire guard 20 therefore places the wire 130 in a substantially z-shaped configuration and maintains the wire in this configuration while yard equipment is operated along and in proximity with the interface 112.

Regardless of the configuration of the wire 130, when the wire guard 20 is secured to the concrete 110 the guard acts as a buffer between the wire and yard equipment. In particular, the base 30 and flange 80 (if present) of the wire guard 20 shield the wire 130 from the rotating wire of a weed whacker or the blades of a power edger. This prevents the wire 130 from being damaged or severed while still allowing the necessary yard work to be performed. The visible top surface 82 of the flange 80, having the text or image 86 thereon, acts as a marker to identify the location of the protected wire 130 as long as the wire guard 20 is in place. Once the yard work is completed, the fasteners 140 are removed from the concrete 110 and the wire guard 20 withdrawn from between the concrete and the yard 120 for future use. The wire 130 returns to its initial position or may remain at the deeper location within the yard 120 when the guard 20 is removed. In either case, the wire 130 is undamaged and fully functional following use of the yard equipment due to the wire guard 20.

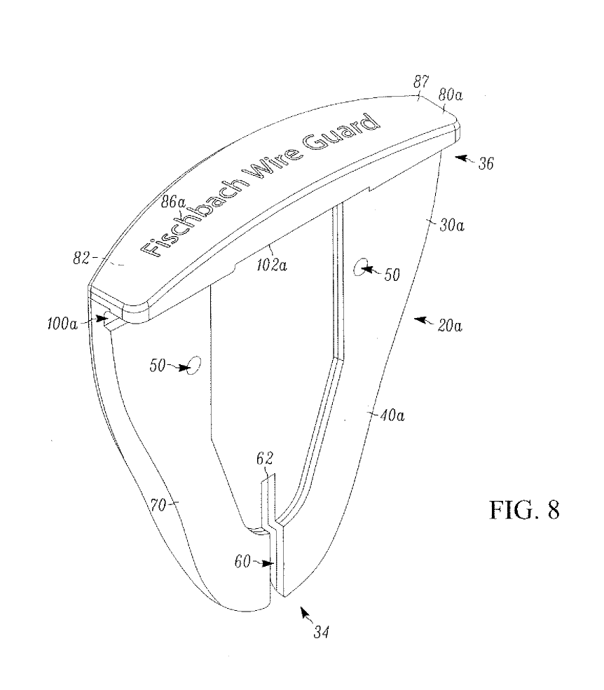

FIG. 8 illustrates a wire guard 20a in accordance with another aspect of the present invention. Features in FIG. 8 that are similar to features illustrated in FIGS. 1-7 are given the same reference numerals whereas features in FIG. 8 that are different from those illustrated in FIGS. 1-7 are given the suffix “a”. In FIG. 8, the notch 102a in the flange 80a of the wire guard 20a has a rectangular shape. The slot 100a in the wire guard 20a is also wider than the slot 100 in the wire guard 20 and the bottom surface 40a of the base 30a is provided with fewer reinforcing members 70. Moreover, the text or image 86a is provided on a separate plate 87 that snaps onto or is otherwise releasably secured to the flange 80. Such a releasable configuration allows the user to readily change or remove the text or image 86a from the flange 80. The wire guard 20a of FIG. 8 is installed in the same manner as the wire guard 20 of FIGS. 1-7 and protects the wire 130 in the same manner as the wire guard of FIGS. 1-7.

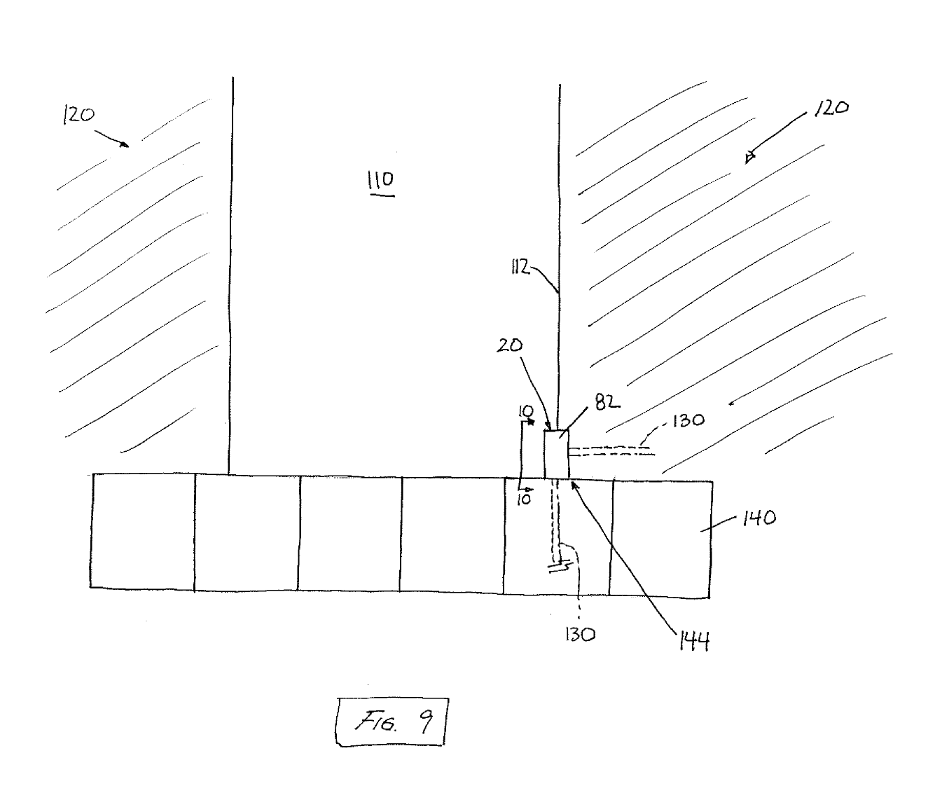

FIGS. 9-10 illustrate an alternative placement and use of the wire guard 20 of the present invention. More specifically, the horizontal slot 100 in the bottom surface 40 of the base 30 allows the wire guard 20 to be used where different ground portions intersect at a corner. For example, the wire guard 20 may be used where the concrete 110 of a driveway intersects both the yard 120 and the sidewalk 140. More specifically, the wire guard 20 is used to protect the wire 130 running underneath or through the sidewalk 140 and entering the yard 120 near the corner 144 of the yard adjacent the concrete 110 of the driveway.

In this instance, the wire guard 20 is inserted at the corner 144 such that the bottom surface 40 of the base 30 faces towards and engages the concrete 110 while the top surface 38 faces towards and engages the yard 120. The wire guard 20 is inserted in the corner 144 such that the slot 100 is positioned adjacent the interface 146 between the concrete 110, yard 120, and sidewalk 140. In this configuration, the wire 130 may laterally enter the wire guard 20 via the slot 100. The wire 130 is guided along the bottom surface 40 of the base 30 by the slot 100, travels towards the second end 34 of the base, and passes through the slot 60 into the yard 120. The wire guard 20 therefore protects the wire 130 located at the corner 144 from impacts while providing a visual indication of the wire via the top surface 82 of the flange 80.

The wire guard of the present invention is advantages over prior attempts to maintain visual identification of the location of underground wires, e.g., using rocks or spray paint, which may easily become dislodged, moved or washed away with rain. More specifically, the wire guard provides a visible marker for the protected wire while exhibiting a durable construction that protects the wire from yard equipment impacts. The wire guard of the present invention is also readily installed and removed and can be used at any interface between surfaces where protection of underground wires or cables is desired.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. A guard for protecting wire along an interface between first and second portions of ground comprising:
a base extending along a centerline from a first end to a second end and having a first surface and an opposing second surface, the first surface for engaging the first ground portion and the second surface for engaging the second ground portion; and
a slot extending from the first end towards the second end for receiving the wire such that the second end of the base protects the wire from impact.

2. The guard of claim 1, wherein the base further includes at least one opening for receiving a fastener to secure the base to the first ground portion.

3. The guard of claim 2, wherein each opening is elongated for allowing the base to move along the centerline relative to the first ground portion when the fastener is secured to the first ground portion.

4. The guard of claim 1 further comprising a plurality of reinforcing ribs on the first surface.

5. The guard of claim 1 further comprising a flange that extends transversely from the first surface of the base for engaging an upwardly facing surface of the first ground portion.

6. The guard of claim 5, wherein the flange includes a top surface and a bottom surface, at least one of text and an image being provided on the top surface and being visible when the wire guard engages the first and second ground portions.

7. The guard of claim 5 further comprising a slot that extends across the first surface of the base and transverse to the centerline, the slot being positioned adjacent to the bottom surface of the flange and receives a portion of the wire.

8. The guard of claim 5, wherein the flange includes a top surface and a bottom surface, the bottom surface including a notch for receiving a portion of the wire.

9. A method for protecting wire along an interface between first and second ground portions comprising:
providing a wire guard having a base extending along a centerline from a first end to a second end, the base further including a slot extending from the first end towards the second end;
locating the wire;
inserting the wire guard along the interface between the first and second ground portions until the wire is positioned within the slot in the base such that the second end of the base protects the wire from impact.

10. The method of claim 9 further comprising inserting a fastener into at least one opening in the base to secure the wire guard to the first ground portion.

11. The method of claim 10, wherein each opening is elongated such that the wire guard is capable of moving along the centerline relative to the fastener while the fastener is secured to the first ground portion.

12. The method of claim 9, wherein the base includes a first surface that engages the first ground portion and an opposing second surface that engages the second ground portion.

13. The method of claim 9, wherein a flange extends transversely from the base of the wire guard, the wire guard being inserted between the first and second ground portions until the flange abuts an upper surface of the first ground portion.

14. The method of claim 9, wherein the step of inserting the wire guard comprises inserting the wire guard between concrete and a yard.

15. A guard for protecting wire along an interface between first and second portions of ground comprising:
a base extending along a centerline from a first end to a second end and having a first surface and an opposing second surface, the first surface for engaging the first ground portion and the second surface for engaging the second ground portion;
a flange extending transversely from the first surface of the base for engaging an upwardly facing surface of the first ground portion;
a plurality of openings extending through the base for receiving fasteners to secure the base to the first ground portion; and
a slot extending from the first end towards the second end for receiving the wire while the flange engages the first ground portion such that the second end of the base protects the wire from impact.
